(19) United States
(12) Patent Application Publication
(10) Pub. No.: US 2020/0037129 A1
(43) Pub. Date: Jan. 30, 2020

(54) Fleet To Fleet Network

(71) Applicant: FORD GLOBAL TECHNOLOGIES, LLC, Dearborn, MI (US)

(72) Inventor: Abraham Mezaael, Southfield, MI (US)

(21) Appl. No.: 16/047,331

(22) Filed: Jul. 27, 2018

(51) Int. Cl. H04W 4/44; H04L 29/08; H04W 4/80; H04W 4/029; H04W 4/021

(52) U.S. Cl. CPC H04W 4/44; H04L 67/12; H04W 4/021; H04W 4/029; H04W 4/80

(57) ABSTRACT

A vehicle comprises a processor configured to responsive to detecting a fleet within a predetermined range, connect to the fleet via a wireless connection; designate the vehicle or one of the vehicles of the fleet to be a lead vehicle and the rest to be follower vehicles; and communicate to a remote server via the lead vehicle through the wireless connection.

### TECHNICAL FIELD

The present disclosure is generally related to a vehicle network. More specifically, the present disclosure is related to vehicle network using fleet to fleet (F2F) network sharing.

### BACKGROUND

Many modern vehicles are equipped with telematics and infotainment systems which may consume a lot of mobile data during a trip. Vehicles within proximity to each other may download and use the same data at the same time (e.g., map and traffic data) individually.

### SUMMARY

In one or more illustrative embodiments of the present disclosure, a vehicle comprises a processor configured to responsive to detecting a fleet within a predetermined range, connect to the fleet via a wireless connection; designate the vehicle or one of the vehicles of the fleet to be a lead vehicle and the rest to be follower vehicles; and communicate to a remote server via the lead vehicle through the wireless connection.

In one or more illustrative embodiments of the present disclosure, a method for a vehicle comprises detecting a fleet for connection mode within a predetermined range; establishing a wireless connection between the vehicle and the fleet; designating one of the vehicles of the fleet to be a lead vehicle and the rest to be a follower vehicles; communicating predefined low priority data through the lead vehicle using the wireless connection; and communicating predefined high priority data to a wireless network directly.

In one or more illustrative embodiments of the present disclosure, a vehicle comprises a processor configured to predict a fleet to be within a predetermined range from the vehicle using location and navigation data from a cloud; responsive to predicting result, pre-arrange low priority data to be communicated collectively via the fleet, and high priority data to be communicated individually.

The details of one or more implementations are set forth in the accompanying drawings and the description below. Other features and advantages will become apparent from the description, the drawings, and the claims.

### BRIEF DESCRIPTION OF THE DRAWINGS

For a better understanding of the invention and to show how it may be performed, embodiments thereof will now be described, by way of non-limiting example only, with reference to the accompanying drawings, in which:

FIG. 1 illustrates an example block topology of a vehicle system of one embodiment of the present disclosure;

FIG. 2 illustrates an example flow diagram for vehicle connection mode of one embodiment of the present disclosure;

FIG. 3 illustrates an example topology of the vehicle system of one embodiment of the present disclosure; and

FIG. 4 illustrates an example data flow diagram of the vehicle network of one embodiment of the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The present disclosure generally provides for a plurality of circuits or other electrical devices. All references to the circuits and other electrical devices, and the functionality provided by each, are not intended to be limited to encompassing only what is illustrated and described herein. While particular labels may be assigned to the various circuits or other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programed to perform any number of the functions as disclosed.

The present disclosure, among other things, proposes a vehicle system for network sharing. More specifically, the present disclosure proposes a vehicle system allowing a plurality of vehicles located within a predefined proximity to access a wireless network through a designated vehicle to save data, power and fuel.

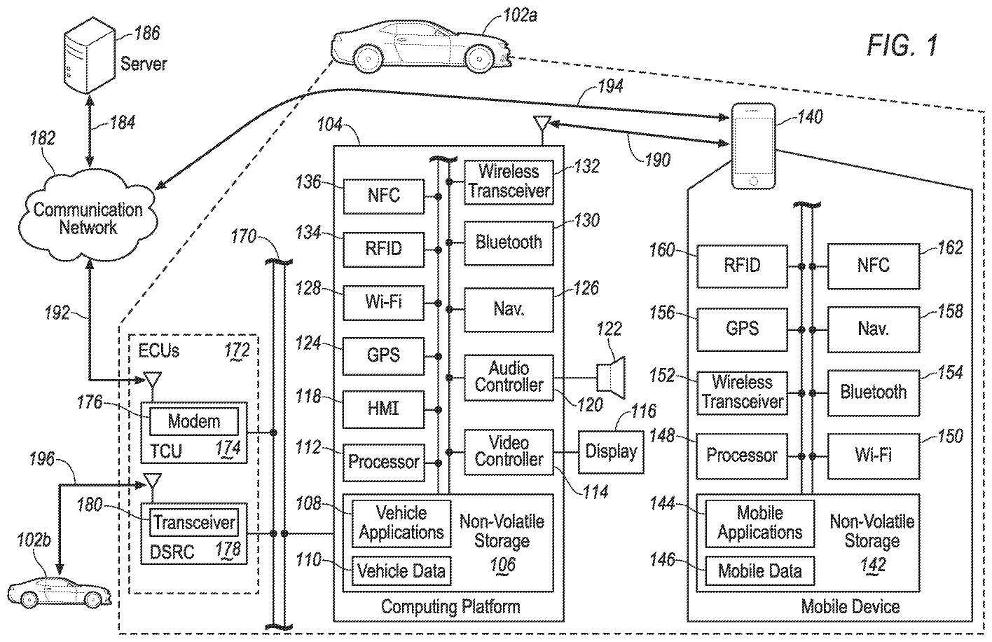

Referring to FIG. 1, an example block topology of a vehicle system 100 of one embodiment of the present disclosure is illustrated. Vehicles 102 may include various types of automobile, crossover utility vehicle (CUV), sport utility vehicle (SUV), truck, recreational vehicle (RV), boat, plane, or other mobile machine for transporting people or goods. In many cases, the vehicle 102 may be powered by an internal combustion engine. As another possibility, vehicles 102 may be a hybrid electric vehicle (HEV) powered by both an internal combustion engine and one or move electric motors, such as a series hybrid electric vehicle (SHEV), a parallel hybrid electric vehicle (PHEV), or a parallel/series hybrid vehicle (PSHEV), a boat, a plane or other mobile machine for transporting people or goods. As an example, the system 100 may include the SYNC system manufactured by The Ford Motor Company of Dearborn, Mich. It should be noted that the illustrated system 100 is merely an example, and more, fewer, and/or differently located elements may be used.

Different vehicles 102 may vary in configurations. The following embodiment is illustrated with reference to vehicle 102a. As illustrated in FIG. 1, a computing platform 104 may include one or more processors 112 configured to perform instructions, commands, and other routines in support of the processes described herein. For instance, the computing platform 104 may be configured to execute instructions of vehicle applications 108 to provide features such as navigation, satellite radio decoding, and communications. Such instructions and other data may be maintained in a non-volatile manner using a variety of types of computer-readable storage medium 106. The computer-readable medium 106 (also referred to as a processor-readable medium or storage) includes any non-transitory medium (e.g., tangible medium) that participates in providing instructions or other data that may be read by the processor 112 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The computing platform 104 may be provided with various features allowing the vehicle occupants/users to interface with the computing platform 104. For example, the computing platform 104 may receive input from human-machine interface (HMI) controls 118 configured to provide for occupant interaction with vehicle 102a. As an example, the computing platform 104 may interface with one or more buttons (not shown) or other HMI controls configured to invoke functions on the computing platform 104 (e.g., steering wheel audio buttons, a push-to-talk button, instrument panel controls, etc.).

The computing platform 104 may also drive or otherwise communicate with one or more displays 116 configured to provide visual output to vehicle occupants by way of a video controller 114. In some cases, the display 116 may be a touch screen further configured to receive user touch input via the video controller 114, while in other cases the display 116 may be a display only, without touch input capabilities. The computing platform 104 may also drive or otherwise communicate with one or more speakers 122 configured to provide audio output to vehicle occupants by way of an audio controller 120.

The computing platform 104 may also be provided with navigation and route planning functions through a navigation controller 126 configured to calculate navigation routes responsive to user input via e.g., the HMI controls 118, and output planned routes and instructions via the speaker 122 and the display 116. Location data that is needed for navigation may be collected from a global positioning system (GPS) controller 124 configured to communicate with GPS satellites and calculate the location of vehicle 102a. Map data used for route planning may be stored in the storage 106 as a part of the vehicle data 110. Navigation software may be stored in the storage 116 as a part of the vehicle applications 108. Additionally, the location and planned route may be wirelessly reported to a remote server 186 for analysis purposes which will be discussed in detail below.

The computing platform 104 may be configured to communicate with a mobile device 140 of the vehicle users/occupants via a wireless connection 190. The mobile device 140 may be any of various types of portable computing device, such as cellular phones, tablet computers, smart watches, laptop computers, portable music players, or other device capable of communication with the computing platform 104. In many examples, the computing platform 104 may include a wireless transceiver 132 in communication with a WiFi controller 128, a Bluetooth controller 130, a radio-frequency identification (RFID) controller 134, a near-field communication (NFC) controller 136, and other controllers such as a Zigbee transceiver, an IrDA transceiver (not shown), configured to communicate with a compatible wireless transceiver 152 of the mobile device 140.

The mobile device 140 may be provided with a processor 148 configured to perform instructions, commands, and other routines in support of the processes such as navigation, telephone, wireless communication, and multi-media processing. For instance, the mobile device 140 may be provided with location and navigation functions via a navigation controller 158 and a GPS controller 156 controlled by application as a part of a mobile application 144 stored in a non-volatile storage 142. Map data used for navigation purposes may be stored in the storage 142 as a part of mobile data 146. Alternatively, the mobile device 140 may be configured to download live map and traffic data from a remote server via a communication network 180 through a wireless connection 194.

The mobile device 140 may be provided with a wireless transceiver 152 in communication with a WiFi controller 150, a Bluetooth controller 154, a RFID controller 160, a NFC controller 162, and other controllers (not shown), configured to communicate with the wireless transceiver 132 of the computing platform 104.

The computing platform 104 may be further configured to communicate with various electronic control units (ECUs) via one or more in-vehicle network 170. The in-vehicle network 170 may include, but is not limited to, one or more of a controller area network (CAN), an Ethernet network, and a media oriented system transport (MOST), as some examples.

Vehicle 102a may include multiple ECUs 172 configured to control and operate various functions of the vehicle 102a. As a few non-limiting examples, the ECUs 172 may include a telematics control unit (TCU) configured to control telecommunication between vehicle 102a and a communication network 182 through a wireless connection 192 using a modem 176. The communication network 182 may be a cellular (e.g., 3G, 4G, and/or 5G) network enabling the communication between a remote server 186 and the computing platform 104. Additionally, the ECUs 172 may include a dedicated short rage communications (DSRC) controller 178 having a transceiver 180 configured to communicate with compatible controllers of other vehicles (e.g., vehicle 102b) via a wireless connection 196. Additionally or alternatively, wireless connections may be established between multiple vehicles 102 using other types of technologies, such as WiFi, Bluetooth, RFID, NFC and etc.

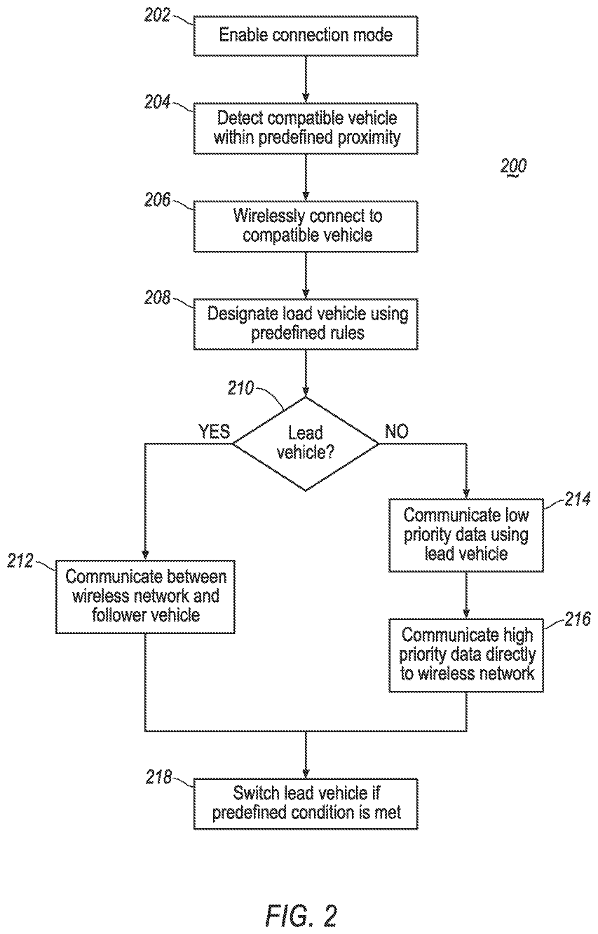

Referring to FIG. 2, a flow diagram for vehicle connection process 200 of one embodiment of the present disclosure is illustrated. With continuing reference to FIG. 1, at operation 202, the computing platform 104 of vehicle 102a enables connection mode by activating the DSRC controller 178 and/or the wireless transceiver 132 to allow the wireless detection of a compatible vehicle 102b. In addition, the computing platform 104 may make itself visible to other vehicles having the compatible platform with the connection mode enabled. At operation 204, the computing platform 104 detects the compatible vehicle 102b is within a predefined proximity from the vehicle 102a. For instance, the computing platform 104 may determine the compatibility of vehicle 102b using a predetermined fleet identification number (FIN) assigned to a manufacturer. The computing platform 104 may detect the vehicle 102b having the compatible FIN within a predefined proximity (e.g., 30 feet) using various technologies, such as GPS, and/or wireless connection signals including DSRC, WiFi, Bluetooth, RFID, NFC and etc.

At operation 206, the computing platform 104 connects to the compatible vehicle 102b via the wireless connection 196. The wireless connection 196 may be a DSRC connection as illustrated in FIG. 1. Additionally or alternatively, the wireless connection 196 may be any type of connection using the wireless transceiver in communication with any compatible wireless controllers discussed above. Responsive to a successful establishment of the wireless connection 196, at operation 208, the computing platform 104 designates a lead vehicle for communication. The designation may be performed using predefined rules taking into account various factors, a few examples of which may include vehicle fuel level, vehicle battery level, signal strength, wireless data subscription package and etc. It is noted that although the designation operation 208 is performed by the computing platform 104 of vehicle 102a in the present example, the designation may as well be performed in a collaborative manner between the multiple vehicles 102. Additionally or alternatively, the lead vehicle may be designated manually be vehicle users. A message may be prompted via HMI controls 118 to allow users of each vehicle to volunteer to be the lead vehicle.

With continuing reference to FIG. 1, if the computing platform 104 of the vehicle 102a is designated to be the lead vehicle, the process proceeds from operation 210 to operation 212. At operation 212, the computing platform 104 of the lead vehicle 102a communicates between the wireless network 182 and the follower vehicle 102b in a F2F mode. The communication may be performed in a real-time manner like a “hotspot.” Alternatively, some data may be communicated in a delayed/buffered manner to same energy and bandwidth. The computing platform 104 may receive data from the follower vehicle 102b and the communication network 182 and buffer it in the storage 106 as a part of vehicle data 110, and send all data out at once at a predetermined time interval (e.g., every 30 seconds).

If the computing platform 104 of vehicle 102a is not designated to be the lead vehicle, the process proceeds to operation 214. The computing platform 104 of vehicle 102a communicates low priority data to the server 186 via the compatible vehicle 102b which is designated to lead the communication. As a few non-limiting examples, the low priority data may include GPS, speed, temperature, idling status data and etc. At operation 216, the computing platform 104 still communicates high priority data directly to the communication network 182 through TCU 174 without going through the lead vehicle 102b. Examples of high priority data may include: airbag deployment, diagnostic trouble codes, tire pressure, vehicle health data, emergency communication and etc.

The designation of the lead vehicle may be switched between multiple compatible vehicles 102. At operation 218, the computing platform 104 switches the lead vehicle if a switching condition is met. The switching condition may include various events. For instance, the computing platform 104 may switch the lead vehicle responsive to connecting to another compatible vehicle which is more suitable to be designated to lead at operation 208. Additionally or alternatively, the lead vehicle may be switched at a fix time interval (e.g., every 3 mins) and/or data amount (e.g., 100 MB) to more evenly distribute the workload among the compatible vehicles 102.

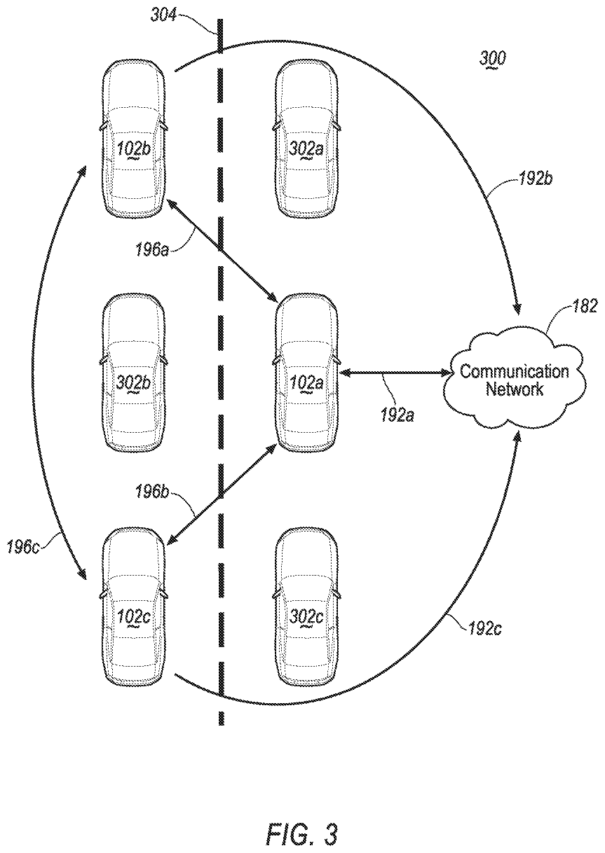

The operations of process 200 may be applied to various situations. Referring to FIG. 3, an example topology diagram for the vehicle communication system of one embodiment of the present disclosure is illustrated. In this example, six vehicles 102a, 102b, 102c, 302a, 302b, and 302c are travelling on a roadway 304. Among the vehicles, three vehicles 102a, 102b, and 102c are equipped with computing platforms 104 (or equivalent systems) that are compatible with each other having the connection mode enabled. The rest three vehicles 302a, 302b, and 302c are non-compatible vehicles.

Each of the compatible vehicles 102 may detect the one another within a predefined proximity using various technologies such as the same/compatible FIN with GPS proximity data, DSRC, infrared, Wi-Fi, Bluetooth, RFID, NFC and etc. Additionally or alternatively, in cases vehicles 102 having navigation routes planned out using the navigation controller 158, computing platforms 104 may predict the compatible vehicles 102 to be at the same location at a particular time through the remote server 186. Other vehicles 302a, 302b and 302c may also be present at the same location. However, they are not connected to vehicles 102 due to their incompatibility with the connection system.

Responsive to detecting one another within the predefined proximity, compatible vehicles 102 may connect to each other via the wireless connection 196 using the above-mentioned technologies. The predefined proximity may vary due different types of detection and connection technologies. For instance, DSRC connections have a longer range as compared to NFC connections in general. Therefore, compatible vehicles 102 may switch the wireless connections 196 between various technologies as the vehicles travel and the distances between them change for optimized results. For security reasons, the wireless connections 196 may be encrypted.

Next, one of the compatible vehicles 102 is designed to be the lead vehicle to lead the communication. The designation may be conducted automatically between the vehicles 102 using various factors such as vehicle health, signal strength, vehicle usage time at etc. Alternatively, the computing platform 104 may allow users of vehicles 102 to volunteer to be the lead vehicle manually. In the example illustrated in FIG. 3, the vehicle 102a is designated to be the lead vehicle to communicate with the communication network via the wireless connection 192a. While the follower vehicles 102b, 102c still use their own direct wireless connections 192b, 192c to communicate high priority data to the communication network 182, low priority data is communicated through the lead vehicle 102a via the F2F wireless connections 196a, 196b. For instance, low priority data may include blind spot alerts; vehicle period data; vehicle speed; GPS/geo-fencing data; odometer; radar data; information alerts; data configurable by fleet manager/authorized user; and etc.

The operations of process 200 may be applied to other scenarios such as fleet vehicle shipments; group of fleet/business vehicles driving to the same destination for service, or dealer; railroad crossing when train is passing; drawbridges; traffic during rush hour or accidents; loading and unloading goods; customs/borders; rest area and weight scale areas; and etc.

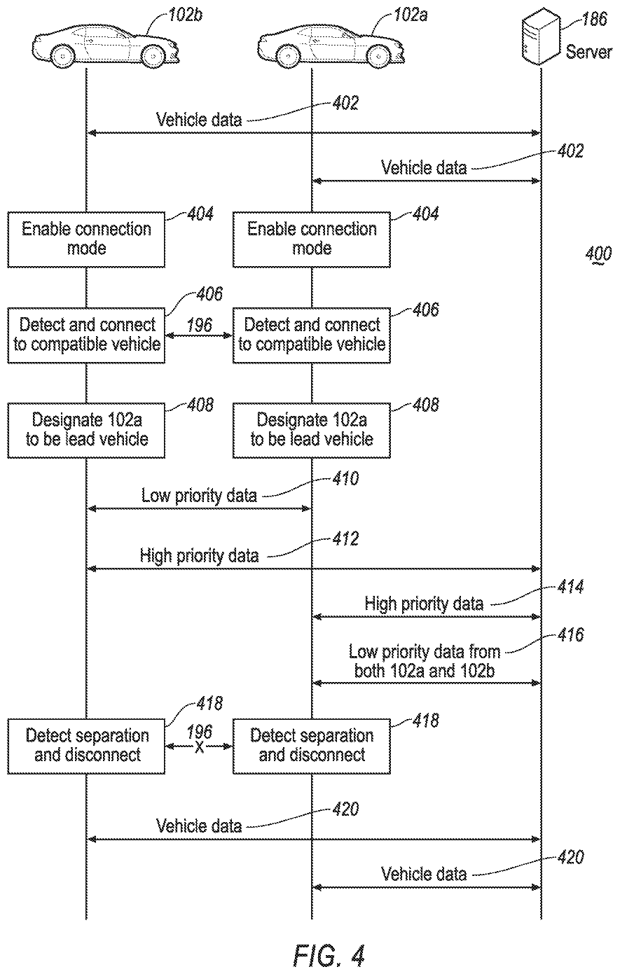

Referring to FIG. 4, an example data flow diagram 400 for the vehicle network system of one embodiment of the present disclosure is illustrated. In this example, two compatible vehicles 102a and 102b are connected to the remote server 186 via the communication network 182 (not shown). At 402, before the vehicles detect each other or the connection mode is enabled, both vehicles 102a and 102b communications with the remote server 186 individually. Data transmitted between the vehicles 102a, 102b and the server 186 include both high priority and low priority data. At 404, the connection mode is enabled on both vehicles 102a, 102b. For instance, the connection mode may be manually switched on by a user of the vehicles 102a, 102b; alternatively, the connection mode may be automatically enabled using predefined configurations of the computing platforms 104 or the server 186.

At 406, vehicles 102a and 102b detect the presence of the other vehicle and connect to each other by establishing a wireless connection 196 using various technologies discusses above. Using the wireless connection 196, the vehicles 102a and 102b communicates information such as vehicle health, signal strength, data package plan, and vehicle configuration to designate a lead vehicle at 408. In the present example, vehicle 102a is designated to be the lead vehicle.

At 410, the follower vehicle 102b sends low priority data to the lead vehicle 102a to communicate to the server 186. Meanwhile, at 412, the follower vehicle 102b communicates high priority data directly to the server 186 in a real-time manner without going through the lead vehicle 102a. At 414, the lead vehicle 102a communicates high priority data directly to the server 186 in a real-time manner. At 416, the lead vehicle 102a collectively communicates low priority data from both the lead vehicle 102a and the follower vehicle 102b to the server 186.

At 418, a separation is detected by the two vehicles 102a and 102b and the wireless connection 196 is disconnected. For instance, the separation may be caused by the two vehicles 102a and 102b depart from one another and their distance extends beyond a predefined threshold for the wireless connection 196. At operation 420, the two vehicles 102a and 102b switch back to individual mode and communicate with the server 186 individually.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A vehicle, comprising a processor configured to
responsive to detecting a fleet within a predetermined range of the vehicle, connect to the fleet via a vehicle-to-vehicle wireless connection;
designate the vehicle as lead vehicle and vehicles of the fleet as follower vehicles;
communicate as lead vehicle to a remote server through a mobile network; and
send buffered data received from the fleet to the remote server via the mobile network at a predetermined time interval.

2. The vehicle of claim 1, wherein the processor is further configured to designate the lead vehicle as being the lead vehicle using at least one of the following factors: fuel level, signal strength, vehicle health, data subscription plan of the vehicle and vehicles of the fleet.

3. The vehicle of claim 1, wherein the processor is further configured to detect presence of the fleet as being within the predetermined range using a global positioning system (GPS); and verify compatibility of the fleet using a fleet identification number (FIN) of the fleet.

4. The vehicle of claim 1, wherein the vehicle-to-vehicle wireless connection is performed via at least one of following: Wi-Fi, Bluetooth, dedicated short range communications (DSRC), near field communication (NFC), or radio frequency identification (RFID).

5. (canceled)

6. The vehicle of claim 5, wherein the processor is further configured to, while operating as a follower vehicle, communicate high priority data to the remote server directly through the mobile network, and communicate low priority data to the remote server through the lead vehicle.

7. The vehicle of claim 6, wherein the high priority data includes data descriptive of at least one of: airbag deployment, diagnostic trouble codes, tire pressure, vehicle health data, or emergency communication.

8. The vehicle of claim 6, wherein the low priority data includes data descriptive of at least one of: blind spot alerts, vehicle period data, vehicle speed, GPS/geo-fencing data, odometer, radar data, information alerts, or data configurable by fleet manager/authorized user.

9. The vehicle of claim 1, wherein the processor is further configured to switch the lead vehicle between the vehicle and the fleet responsive to a preconfigured switching condition being met.

10. The vehicle of claim 9, wherein the preconfigured switching condition includes at least one of: a predefined time interval, a predefined data transmission amount, or connecting to second fleet being more eligible to be the lead vehicle.

11. A method for a vehicle, comprising:
detecting a fleet within a predetermined range;
establishing a wireless connection between the vehicle and the fleet;
designating the vehicle to be a lead vehicle and the fleet to be follower vehicles;
receiving predefined low priority data from one of the follower vehicles using the wireless connection; and
communicating the predefined low priority data as received to a wireless network.

12. The method of claim 11, further comprising designating the lead vehicle using at least one of the following factors: fuel level, signal strength, vehicle health, data subscription plan of the vehicle and the fleet.

13. The method of claim 11, further comprising:
detecting the fleet as being within the predetermined range using data from a global positioning system (GPS); and
verifying compatibility of the fleet using a fleet identification number (FIN) identifying the fleet.

14. The method of claim 11, wherein the wireless connection between the vehicle and the fleet include at least one of following types of technology: Wi-Fi, Bluetooth, DSRC, NFC, or RFID.

15. The method of claim 11, further comprising predicting the fleet to be within the predetermined range at a time frame using a navigation route for traversal by the vehicle.

16. The method of claim 11, further comprising, sending the predefined low priority data out in a delayed manner.

17. The method of claim 11, wherein the low priority data includes information indicative of at least one of: blind spot alerts; vehicle period data; vehicle speed; GPS/geo-fencing data; odometer; radar data; information alerts; or data configurable by fleet manager/authorized user.

18. A vehicle, comprising a processor configured to:
predict a fleet to be within a predetermined range from the vehicle using location and navigation data from a cloud server; and
responsive to a result of prediction, pre-arrange predefined low priority data to be communicated collectively to the cloud server via the fleet, and predefined high priority data to be communicated to the cloud server individually.

19. The vehicle of claim 18, wherein the processor is further configured to
responsive to detecting the fleet being within a predetermined range, connect to the fleet via a wireless connection;
designate the vehicle or one of the vehicles of the fleet to be a lead vehicle and the rest to be follower vehicles; and
communicate both the low priority data and the high priority data to the cloud server in a pre-arranged manner.

20. The vehicle of claim 19, wherein the processor is further configured to designate the lead vehicle using at least one of the following factors: fuel level, signal strength, vehicle health, data subscription plan of the vehicle and vehicles of the fleet.
